(19) United States
(12) Patent Application Publication
(10) Pub. No.: US 2005/0156508 A1
(43) Pub. Date: Jul. 21, 2005

(54) Planar light source device and image display apparatus having the same

(76) Inventors: Hyeon-Yong Jang, Osan-si (KR); Hyun-Sook Kim, Seoul (KR); Jae-Hyeon Ko, Suwon-si (KR); Dong-Woo Kim, Suwon-si (KR)

Correspondence Address: CANTOR COLBURN, LLP, 55 GRIFFIN ROAD SOUTH, BLOOMFIELD, CT, 06002, US

(21) Appl. No.: 10/985,129

(22) Filed: Nov. 10, 2004

(30) Foreign Application Priority Data
Nov. 10, 2003 (KR) 2003-79260

(51) Int. Cl. H01J 1/62; H01J 63/04

(52) U.S. Cl. 313/498

(57) ABSTRACT

A planar light source device includes a body, a plurality of partition members, and first and second electrodes. The body includes a discharge space. The partition member divides the discharge space into a plurality of discharge regions. The first electrodes are disposed at the edge portions of the body, and a discharge voltage is applied to the first electrodes. The second electrode is disposed between the partition members. Therefore, the second electrode corresponding to the discharge region prevents deflection to enhance optical characteristics of the planar light source device. Furthermore, the second electrode lowers a discharge start time and reduces a discharging time.

### BACKGROUND OF THE INVENTION

1. Field of the Invention

The present invention relates to a planar light source device and an image display apparatus having the planar light source device, more particularly, to a planar light source device having a flat body and a partition wall that divides the body to form a plurality of discharge regions.

2. Description of the Related Art

Recently, information processing devices having various shapes, functions, processing speeds, etc. have been rapidly developed. Information processed by the information processing devices corresponds to an electric signal. Therefore, a user requires an image display apparatus for displaying the electric signal.

A liquid crystal display apparatus, which is one of the image display apparatuses, displays several images by the motion of liquid crystals. The liquid crystal display apparatus has a thinner thickness, a lighter-weight, a lower-consumed power, low-driven characteristics, etc. than other types of displays. Therefore, the liquid crystal display apparatus is widely used in various fields.

The liquid crystal display apparatus includes a liquid crystal display panel for displaying several images and a backlight assembly for providing the liquid crystal display panel with light.

As a backlight assembly, a cold cathode fluorescent lamp (CCFL) or a light emitting diode (LED) have been generally used. The CCFL has the characteristics of high luminance, long lifespan and less-generated heat. However, both the CCFL and the LED have poor uniformity of luminance.

Therefore, a light guide plate (LGP) and prism sheets may be used to enhance the uniformity of luminance. However, this configuration causes a volume, a weight, and manufacturing cost of the liquid crystal display apparatus to increase.

Most recently, a planar light source device has been developed to solve these problems. The planar light source device includes a body that forms a discharge space, and a plurality of partition members that divide the discharge space into a plurality of discharge regions. The planar light source also includes electrodes that are formed inside or outside of the body. Plasma in the discharge space is generated by a discharge voltage applied to the electrodes.

However, the conventional planar light source device has problems. First, crosstalk between the discharge regions induces deflection. Second, electric charges generated by the discharge voltage are concentrated on the edges of the partition members, thereby the uniformity of luminance becomes poor.

### SUMMARY OF THE INVENTION

The present invention provides a planar light source device capable of reducing the deflection caused by interference between discharge regions to enhance the uniformity of luminance.

The present invention also provides an image display apparatus having the planar light source device.

According to the planar light source device and the image display apparatus having the planar light source device, the second electrodes each corresponding to the discharge regions enhance optical characteristics of the planar light source device.

Furthermore, the second electrode shortens a discharge start time and reduces a discharging time.

In one embodiment, a planar light source device comprises a light source body including a first substrate, a second substrate facing the first substrate, at least one partition member disposed between the first and second substrates, the at least one partition member partitioning a space between the first and second substrates into a plurality of regions, and a sealing member sealing the space between the first and second substrates; a first electrode formed on both ends of the light source body in the direction that is substantially perpendicular to the longitudinal direction of the partition member; and a second electrode formed on the light source body in the direction that is substantially perpendicular to the first electrode, wherein the second electrode is disposed on an area corresponding to one of the regions.

The second electrode is formed between the partition member and the sealing member. Further, the second electrode includes electrode sections each of which is disposed on a corresponding area of the respective regions. The second electrodes are formed in parallel with the partition member by a substantially identical distance and the second electrode is spaced apart from the first electrode. Further, the second electrodes are substantially symmetrical to each other with respect to the central line of the first electrodes and the second electrodes are formed on one of the first and second substrates. The second electrodes are made of a conductive tape or a Silver (Ag) paste.

The first electrode is formed on one of the first and second substrates. The light source body further comprises a first florescent layer formed on an inner surface of the first substrate; a second florescent layer formed on an inner surface of the second substrate facing the inner surface of the first substrate; and a reflection layer disposed between the second substrate and the second florescent layer, wherein the first and second florescent layers are formed one of between the partition members or between the partition member and the sealing member.

The partition members have a first partition member and a second partition member, the first partition member is adjacent to a first inner surface and makes contact with a second inner surface, and the second partition member is adjacent to the second inner surface and makes contact with the first inner surface. Both the first and second partition members make contact with the second inner surface.

In another embodiment, an image display apparatus comprises a planar light source device including a light source body having a first substrate, a second substrate facing the first substrate, at least one partition member disposed between the first and second substrates, the at least one partition member partitioning a space between the first and second substrates into a plurality of regions, and a sealing member sealing the space between the first and second substrates, a first electrode formed on both sides of the light source body in the direction that is substantially perpendicular to the longitudinal direction of the partition member, and a second electrode formed on the light source body in the direction that is substantially perpendicular to the first electrode, the second electrode being formed between the partition members and between the partition member and the sealing member; a receiving container to mount the planar light source device; and a flat panel to convert light generated from the planar light source device into images.

The second electrode is formed on one of the first and second substrates in the direction that is substantially perpendicular to the first electrode. Further, the second electrode is formed one of between the partition members or between the partition member and the sealing member. The number of the second electrodes is more than 1 and the second electrodes are spaced apart from the first electrode. The second electrodes are substantially symmetrical to each other with respect to the central line of the first electrodes. The second electrodes are made of a conductive material or silver (Ag) paste.

These and other objects, features and advantages of the present invention will become apparent from the following detailed description of illustrative embodiments thereof, which is to be read in connection with the accompanying drawings.

This application relies for priority upon Korean Patent Application No. 2003-79260 filed on Nov. 10, 2003, the contents of which are herein incorporated by reference in its entirety.

### BRIEF DESCRIPTION OF THE DRAWINGS

The above and other features and advantage_points of the present invention will become more apparent by describing in detailed exemplary embodiments thereof with reference to the accompanying drawings, in which:

FIG. 1 is a partially cut out perspective view illustrating a planar light source device according to an embodiment of the present invention;

FIG. 2 is a cross-sectional view taken along line 2-2 in FIG. 1;

FIG. 3 is a plan view illustrating an arrangement of second electrodes of the planar light source device in FIG. 1;

FIG. 4 is a plan view illustrating another arrangement of second electrodes of the planar light source device in FIG. 1;

FIGS. 5A to 5D are schematic views illustrating operation of the planar light source device in FIG. 3;

FIG. 6 is a plan view illustrating an arrangement of partition members of the planar light source device in FIG. 1;

FIG. 7 is a plan view illustrating another arrangement of partition members in FIG. 6; and

FIG. 8 is an exploded perspective view illustrating an image display apparatus including the planar light source device in FIG. 1.

### DETAILED DESCRIPTION OF THE INVENTION

Hereinafter the embodiments of the present invention will be described in detail with reference to the accompanied drawings.

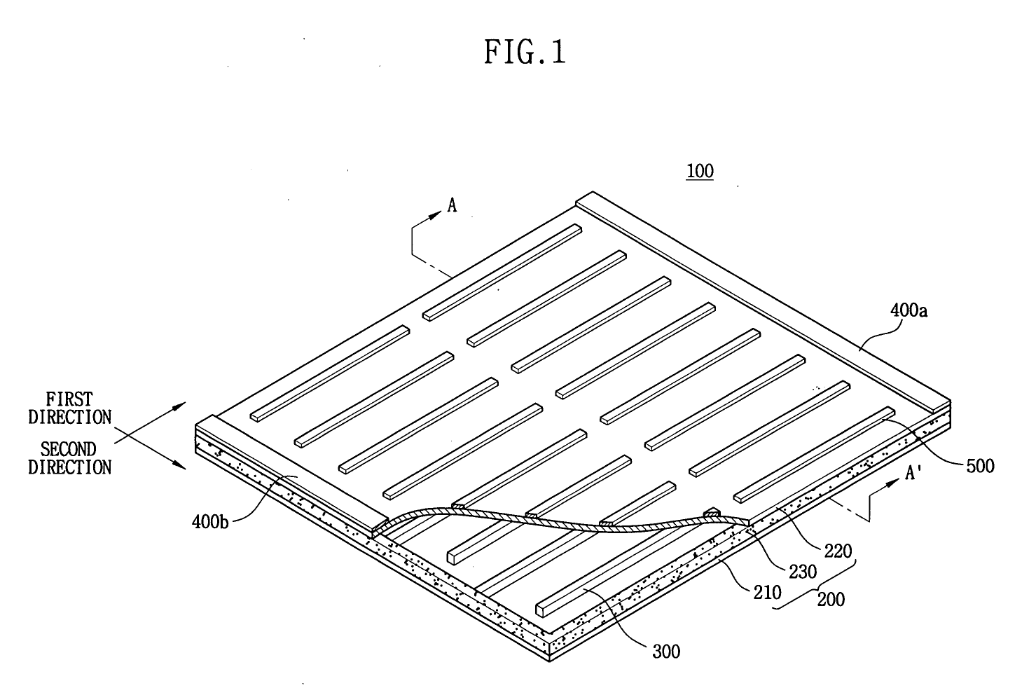

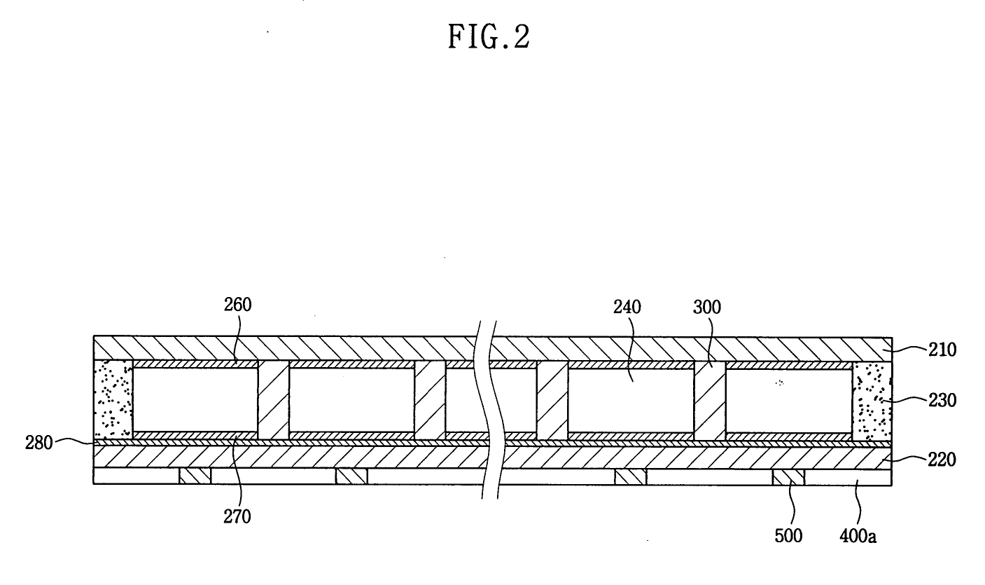

FIG. 1 is a partially cutout perspective view illustrating a planar light source device according to an embodiment of the present invention, and FIG. 2 is a cross-sectional view taken along line 2-2 in FIG. 1.

Referring to FIGS. 1 and 2, the planar light source device 100 according to an embodiment of the present invention includes a light source body 200, a partition member 300, first electrodes 400a and 400b, and a second electrode 500.

The light source body 200 includes a first substrate 210, a second substrate 220 and a sealing member 230. The first and second substrates 210 and 220 face each other. The sealing member 230 is disposed between the first and second substrates 210 and 220 along the edge portions of the first and second substrates 210 and 220 to form a discharge space. In other words, the discharge space is disposed between the first and second substrates 210 and 220 by the sealing member 230.

The first and second substrates 210 and 220 may be a glass substrate that transmits visible light and blocks ultraviolet light. For example, a thickness of the first substrate 210 is one third of a thickness of the second substrate 220. The partition member 300 is disposed in the discharge space of the body 200 and may be disposed in parallel with each other to divide the discharge space into a plurality of discharge regions 240. The partition member 300 makes contact with both the first and second substrates 210 and 220. The sealing member 230 may include the same material as the partition member 300. Therefore, the sealing member 230 may be formed along with the process of forming the partition member 300.

The first electrodes 400a and 400b are formed at the edge portions of the body 200 along a first direction that is substantially perpendicular to a longitudinal direction of the body 200. For example, the first electrodes 400a and 400b are formed on an outer surface of the second substrate 220, and may be formed on an outer surface of the first substrate 210. Plasma in the discharge space is generated by the discharge voltage applied to the first electrodes 400a and 400b.

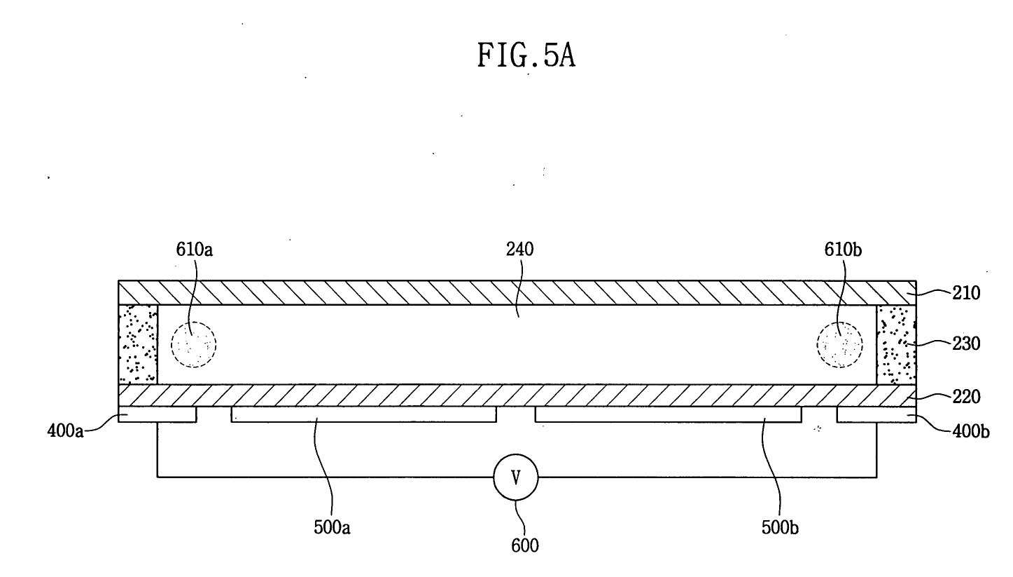

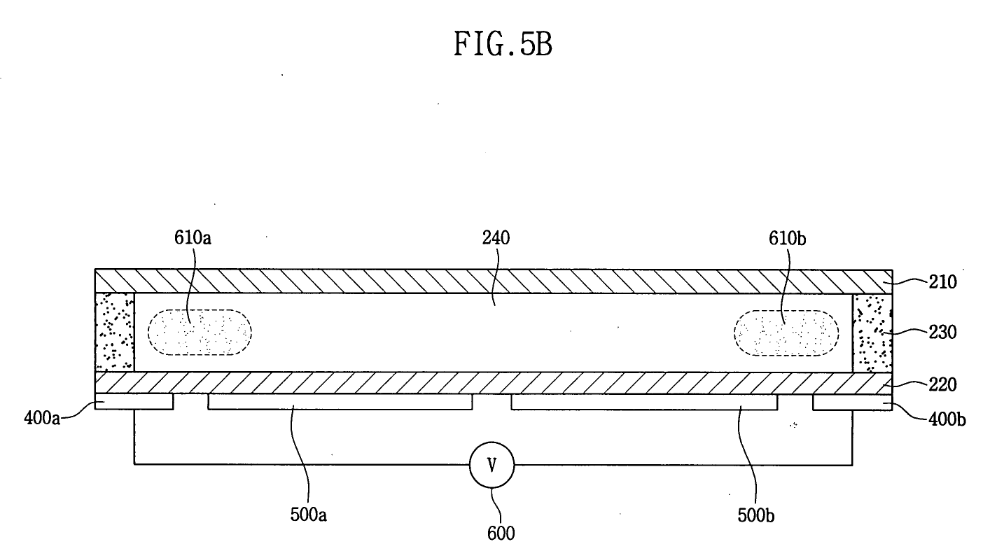

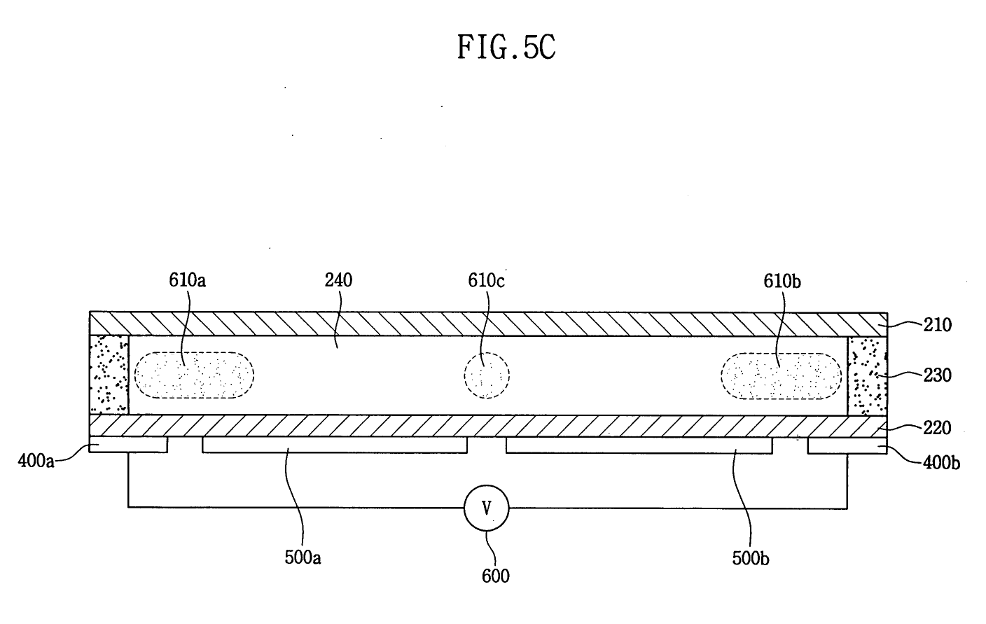

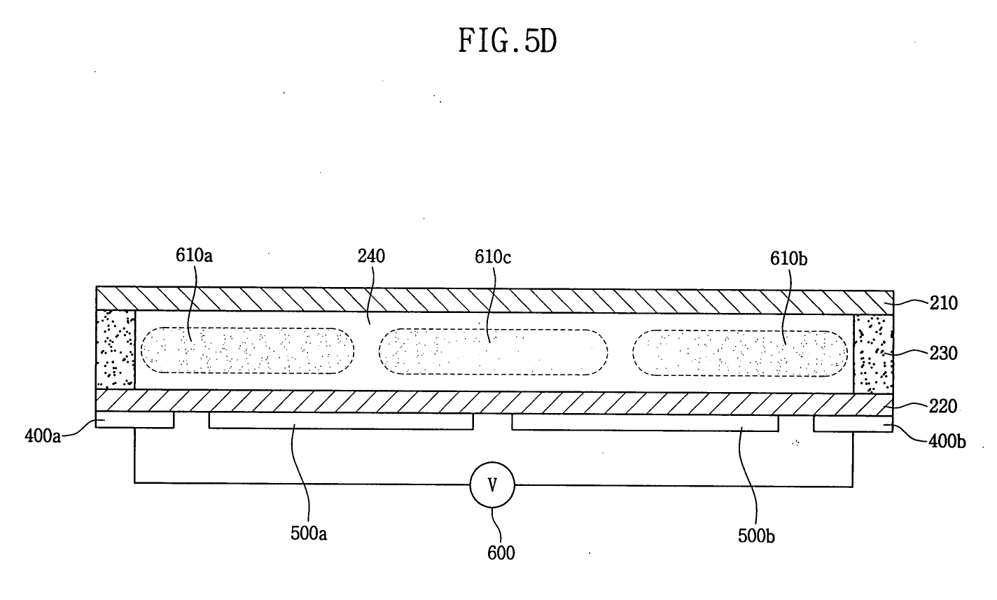

The second electrode 500 is formed on the outer surface of the second substrate 220 along a second direction that is substantially parallel with the longitudinal direction of the body 200. The second electrode 500 is arranged corresponding to the discharge regions 240, respectively. The second electrode 500 is spaced apart by a substantially identical distance along the second direction. The second electrode 500 may be a conductive material, such as silver (Ag) paste, aluminum (Al) tape, etc. The second electrode 500 is in a floating state, for example, the second electrode 500 is not electrically connected to an external power source, or no voltage is applied to the second electrode 500. The second electrode 500 guides plasma generated by the discharge voltage applied to the first electrodes 400a and 400b toward the discharge region 240, and the generated plasma lowers a discharge start voltage. Detailed explanation will be described with refer to FIG. 5.

The planar light source device 100 further includes first and second fluorescent layers 260 and 270. The first fluorescent layer 260 is formed on an inner surface of the first substrate 210, and the second fluorescent layer 270 is formed on an inner surface of the second substrate 220, which faces the inner surface of the first substrate 210. The first and second fluorescent layers 260 and 270 are not formed in the region where the partition member 300 is attached. The first and second fluorescent layers 260 and 270 transform ultraviolet light generated by the plasma into visible light.

The planar light source device 100 may further include a reflection layer 280. The reflection layer 280 is disposed between the second fluorescent layer 270 and the second substrate 220 and reflects the visible light reaching the second substrate 220 in the opposite direction, for example, toward the first substrate 210.

The planar light source device 100 may further include a protection layer (not shown) disposed between the first substrate 210 and the first fluorescent layer 260 and between the second substrate 220 and the reflection layer 280. The protection layer prevents chemical reaction of both the first substrate 210 and mercury (Hg) of discharge gas.

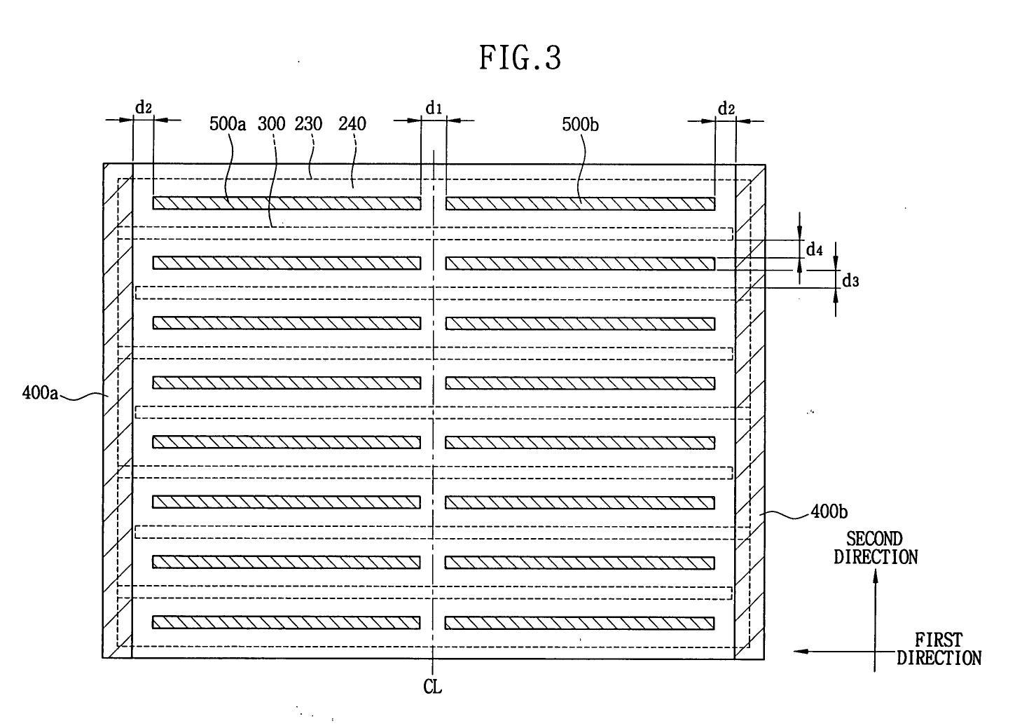

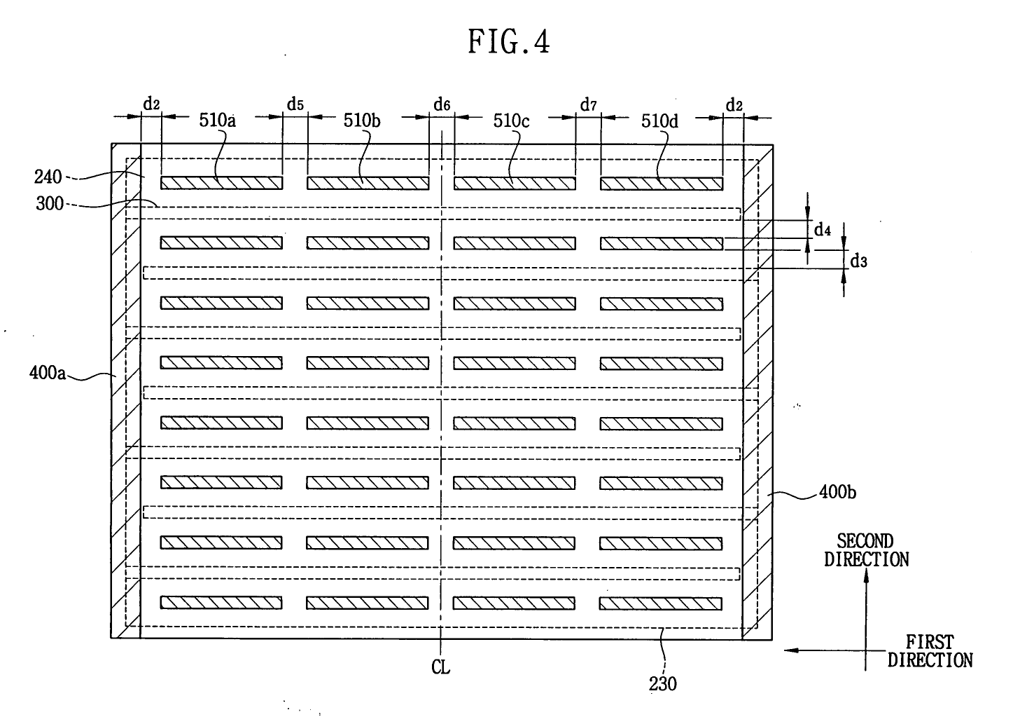

FIG. 3 is a plan view illustrating an arrangement of second electrodes of the planar light source device in FIG. 1, and FIG. 4 is a plan view illustrating another arrangement of second electrodes of the planar light source device in FIG. 1.

Referring to FIG. 3, a second electrode 500 is disposed between partition members 300, and may be disposed between the partition member 300 and the sealing member 230. The second electrode 500 includes first and second electrode sections 500a and 500b. The first and second electrode sections 500a and 500b are formed in the discharge region 240.

The first and second electrode sections 500a and 500b are arranged along a second direction and are spaced apart from each other by a first distance d1. Additionally, the first and second electrode sections 500a and 500b are spaced apart from the first electrodes 400a and 400b by a second distance d2, respectively. The second distance d2 is substantially equal to the first distance d1.

The first and second electrode sections 500a and 500b are disposed between the partition members 300, and may be disposed between the partition member 300 and the sealing member 230. For example, the first and second electrode sections 500a and 500b are spaced apart from the partition member 300 by third and fourth distances d3 and d4, respectively. The third distance d3 is substantially equal to the fourth distance d4.

Furthermore, the first and second electrode sections disposed in the discharge region 240 are substantially symmetrical with respect to a virtual centerline CL of the first electrodes 400a and 400b. Herein, the first and second electrode sections 500a and 500b are disposed in the discharge region 240, but it should be noted that one electrode section may be disposed in a corresponding discharge region 240.

In another embodiment, as shown in FIG. 4, the second electrode 500 includes third, fourth, fifth and sixth electrode sections 510a, 510b, 510c and 510d. The third, fourth, fifth and sixth electrode sections 510a, 510b, 510c and 510d are disposed in the discharge region 240. The third and fourth electrode sections 510a and 510b are spaced apart from each other by a fifth distance d5; the fourth and fifth electrode sections 510b and 510c are spaced apart from each other by a sixth distance d6 and the fifth and sixth electrode sections 510c and 510d are spaced apart from each other by a seventh distance d7. The second distance d2 is substantially equal to the fifth to seventh distances d5, d6 and d7. The fourth and fifth electrode sections 510b and 510c are substantially symmetrical with respect to the virtual centerline CL of the first electrodes 400a and 400b, and the third and sixth electrode sections 510a and 510d are substantially symmetrical with respect to the virtual centerline CL of the first electrodes 400a and 400b. The third, fourth, fifth and sixth electrode sections 510a, 510b, 510c, and 510d are disposed between the partition members 300, and may be disposed between the partition member 300 and the sealing member 230. For example, the third, fourth, fifth and sixth electrode sections 510a, 510b, 510c, and 510d are spaced apart from the partition member 300 by third and fourth distances d3 and d4, respectively. The third distance d3 is substantially equal to the fourth distance d4.

FIGS. 5A to 5D are schematic views illustrating operation of the planar light source device in FIG. 3.

Referring to FIGS. 5A to 5D, the first electrodes 400a and 400b are attached at both sides of the second substrate 220. A discharge gas (not shown), such as mercury (Hg), neon (Ne), etc., exists in the discharge region 240. In order to obtain Penning effect (or to lower a discharge voltage), the discharge gas may include a minute amount of argon (Ar), krypton (Kr), Xenon (Xe), etc.

A discharge start voltage is applied to the first electrodes 400a and 400b, for example, an oscillating voltage ranged from about 1 kV to about 2 kV is applied to the first electrode 400a, and an oscillating voltage with a phase opposite to that of the oscillation voltage applied to the first electrode 400a is applied to the first electrode 400b.

The discharge start voltages each applied to the first electrodes 400a and 400b generate first and second plasmas 610a and 610b in the discharge region 240. For example, the discharge gas near the first electrodes 400a and 400b is transformed into plasma.

Then, the first and second plasmas 610a and 610b spread toward the center portion of the discharge region 240 as shown in FIG. 5B.

When the first and second plasmas 610a and 610b arrive at the region where the second electrodes 500a and 500b are disposed, a voltage is induced at the second electrodes 500a and 500b. For example, the first and second plasmas 610a and 610b have electric charges, so that the first and second plasmas 610a and 610b induce charges at the second electrodes 500a and 500b that are conductors.

When a voltage is induced at the second electrodes 500a and 500b, a third plasma 610c is generated at the region where the second electrodes 500a and 500b neighbor each other, as shown in FIG. 5C. Then, the first and second plasmas 610a and 610b spread toward the center portion of the discharge region 240, and the third plasma 610c spreads toward the edge portion of the discharge region 240, as shown in FIG. 5D.

As described above, the second electrodes 500a and 500b generate the third plasma 610c to reduce a discharge start time and reduce deflection generated in the discharge region 240.

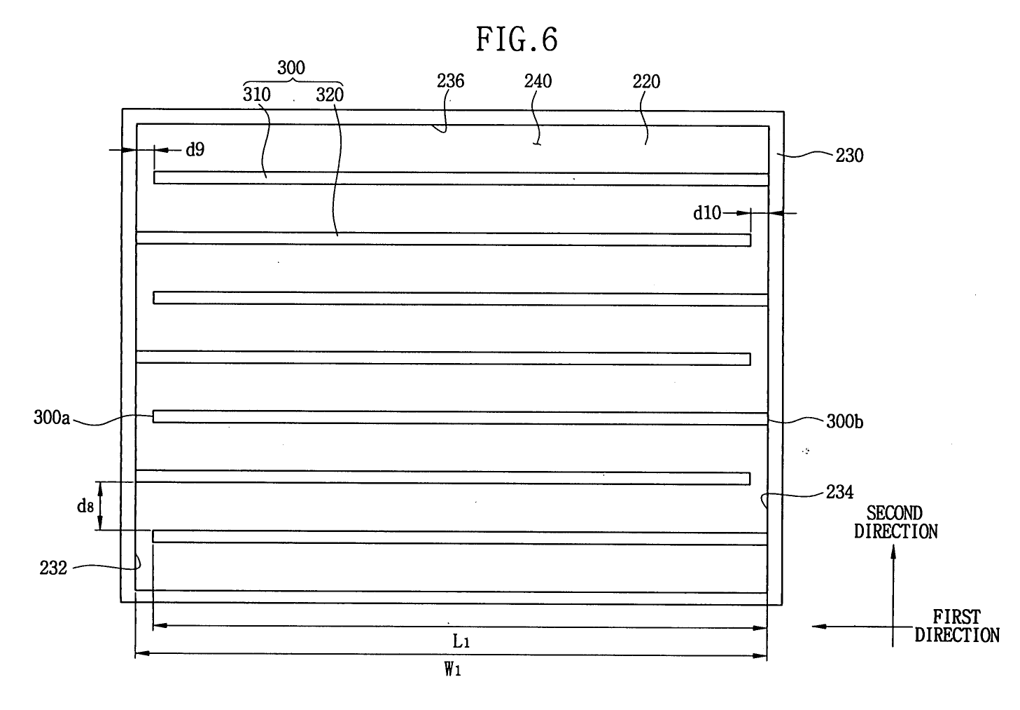

FIG. 6 is a plan view illustrating an arrangement of partition members of the planar light source device in FIG. 1.

Referring to FIG. 6, a partition member 300 is disposed between first and second substrates 210 and 220, so that the partition member 300 divides the discharge space formed between the first and second substrates 210 and 220 into a plurality of discharge regions 240. The partition member 300 may be formed on one of the first and second substrates 210 and 220.

The partition member 300 is extended along a first direction and disposed along a second direction that is substantially perpendicular to the first direction, such that the partition member 300 is spaced apart by an eighth distance d8. The partition member 300 has a bar-shape and a first length L1. The first length L1 is substantially smaller than a first width W1 between first and second inner surfaces 232 and 234.

The partition member 300 has two types of a first and second partition members 310 and 320. The first partition member 310 has a first end 300a that is adjacent to the first inner surface 232 and a second end 300b that makes contact to the second inner surface 234. The second partition member 320 has the first end 300a that is adjacent to the second inner surface 234 and the second end 300b that makes contact to the first inner surface 232. The first end 300a is spaced apart from the first and second surfaces 232 and 234 by ninth and tenth distances d9 and d10, respectively. The ninth distance d9 is substantially equal to the tenth distance d10. The first and second partition members 310 and 320 form a serpentine shape by dividing the discharge space into a plurality of the discharge regions 240. Therefore, the discharge gas in the discharge region 240 spreads uniformly.

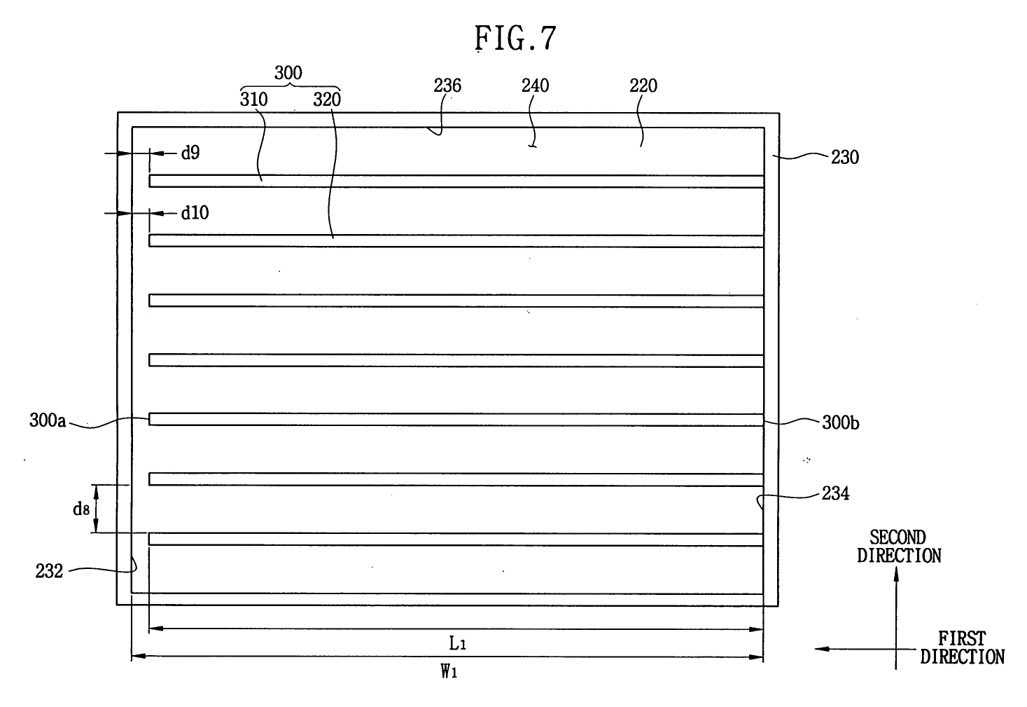

FIG. 7 is a plan view illustrating another arrangement of the partition member 300 in FIG. 6.

The planar light source device has the substantially same configuration as that of the embodiment in FIG. 6 except for the partition member 300. Thus, the same reference numerals will be used to refer to the same or like parts as those described in the embodiment of FIG. 6 and any further explanation will be omitted.

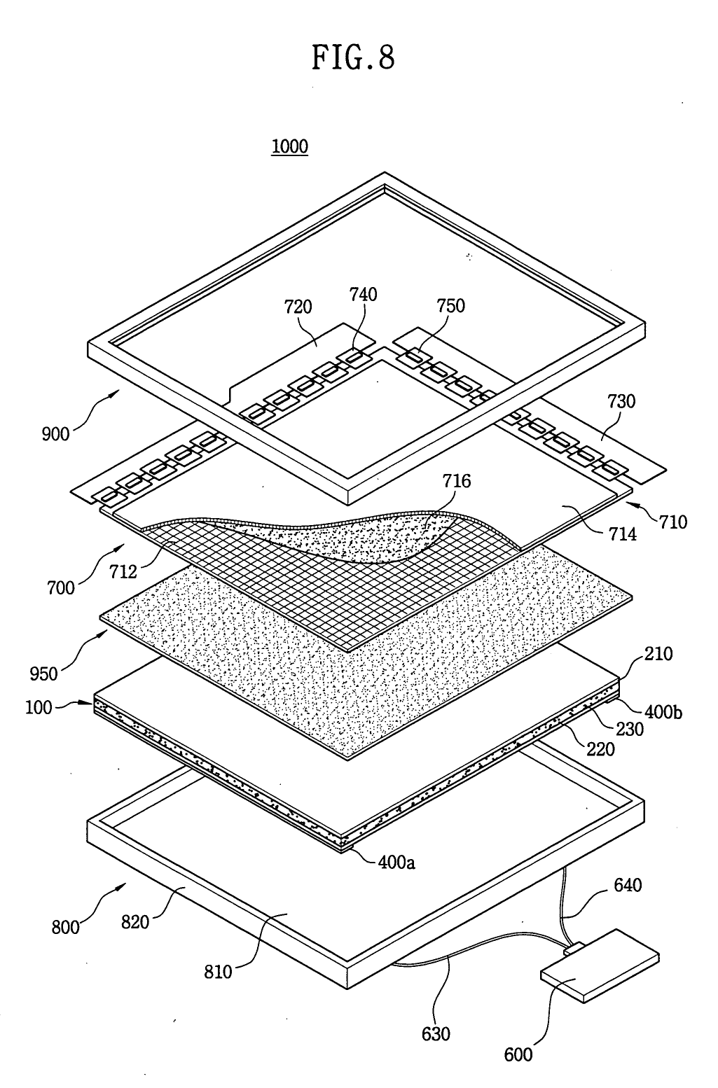

Referring to FIG. 7, all partition members including the first and second partition members 310 and 320 make contact with the second inner surface 234. Therefore, a path between the discharge regions 240 is disposed near the first inner surface 232. The first and second partition members 310 and 320 are spaced apart from ninth and tenth distance d9 and d10, respectively. The ninth distance d9 is substantially equal to the tenth distance d10. The partition member 300 may not make contact with both the first and second inner surfaces 232 and 234, or may make contact with both the first and second inner surfaces 232 and 234. FIG. 8 is an exploded perspective view illustrating a liquid crystal display apparatus including the planar light source device in FIG. 1.

Referring to FIG. 8, a liquid crystal display apparatus 1000 includes a planar light source device 100, a display unit 700, and a receiving container 800. The display unit 700 includes a liquid crystal display panel 710 for displaying images, and data and gate printed circuit boards 720 and 730 for providing the liquid crystal display panel 710 with driving signals. The data and gate printed circuit boards 720 and 730 are electrically connected to data and gate tape carrier packages 740 and 750, respectively.

The liquid crystal display panel 710 includes a thin film transistor substrate 712, a color filter substrate 714 facing the thin film transistor substrate 712, and a liquid crystal layer 716 interposed between the thin film transistor substrate 712 and the color filter substrate 714. The thin film transistor substrate 712 corresponds to a glass substrate having thin film transistor (not shown) formed thereon. The thin film transistor operates as a switching device. The thin film transistor includes a gate electrode that is electrically connected to a gate line, a source electrode that is electrically connected to a data line, and a drain electrode that is electrically connected to a pixel electrode. The pixel electrode includes an optically transparent and electrically conductive material, for example, indium tin oxide (ITO), indium zinc oxide (IZO), etc. The color filter substrate 714 includes RGB color filters, and a common electrode including an optically transparent and electrically conductive material, for example, indium tin oxide (ITO), indium zinc oxide (IZO), etc.

The receiving container 800 includes a bottom plate 810 and sidewalls 820 protruded from an edge portion of the bottom plate 810 to form a receiving space. The receiving container 800 fixes the planar light source device 100 and the liquid crystal display panel 710. The bottom plate 810 has enough area to support the planar light source device 100, and has the substantially same shape as that of the planar light source device 100. For example, both the bottom plate 810 and the planar light source device 100 have a rectangular shape. The sidewalls 820 secure the planar light source device 100.

The liquid crystal display apparatus 1000 further includes an inverter 600 and a top chassis 900. The inverter 600 is disposed outside of the receiving container 800, and generates a discharge voltage for driving the planar light source device 100. The discharge voltage generated from the inverter 600 is applied to the planar light source device 100 via first and second wires 630 and 640. The first and second wires 630 and 640 are electrically connected to the first electrodes 400a and 400b formed on the edge portions of the planar light source device 100, respectively. The first and second wires 630 and 640 may be electrically connected to the first electrodes 400a and 400b. However, the first and second wires 630 and 640 may be electrically connected to the first electrodes 400a and 400b via a separate connecting member (not shown).

The top chassis 900 surrounds the edge portions of the liquid crystal display panel 710, and is combined with the receiving container 800. The top chassis 900 protects and fixes the liquid crystal display panel 710.

The liquid crystal display apparatus 1000 may further include optical sheets 950 for enhancing optical characteristics. The optical sheets include a diffusion sheet for diffusing light and a prism sheet for condensing light.

According to the planar light source device and the liquid crystal display apparatus having the planar light source device, the second electrode corresponding to the discharge region prevents deflection to enhance optical characteristics of the planar light source device. Furthermore, the second electrode lowers a discharge start time and reduces a discharging time.

Having described he embodiments of the present invention and its advantages, t is noted that various changes, substitutions and alterations can be made herein without departing from the spirit and scope of the invention as defined by appended claims.

1. A planar light source device comprising:
a light source body including a first substrate, a second substrate facing the first substrate, at least one partition member disposed between the first and second substrates, the at least one partition member partitioning a space between the first and second substrates into a plurality of regions, and a sealing member sealing the space between the first and second substrates;
a first electrode formed on both ends of the light source body in the direction that is substantially perpendicular to the longitudinal direction of the partition member; and
a second electrode formed on the light source body in the direction that is substantially perpendicular to the first electrode,
wherein the second electrode is disposed on an area corresponding to one of the regions.

2. The planar light source device of claim 1, wherein the second electrode is formed between the partition member and the sealing member.

3. The planar light source device of claim 1, wherein the second electrode includes electrode sections each of which is disposed on a corresponding area of the respective regions.

4. The planar light source device of claim 3, wherein the second electrodes are formed in parallel with the partition member by a substantially identical distance.

5. The planar light source device of claim 4, wherein the second electrode is spaced apart from the first electrode.

6. The planar light source device of claim 5, wherein the second electrodes are substantially symmetrical to each other with respect to a central line of the first electrodes.

7. The planar light source device of claim 1, wherein the second electrode is formed on one of the first and second substrates.

8. The planar light source device of claim 7, wherein the second electrode is made of a conductive tape.

9. The planar light source device of claim 8, wherein the second electrode is made of a Silver (Ag) paste.

10. The planar light source device of claim 1, wherein the first electrode is formed on one of the first and second substrates.

11. The planar light source device of claim 10, wherein the light source body further comprises:
a first florescent layer formed on an inner surface of the first substrate;
a second florescent layer formed on an inner surface of the second substrate facing the inner surface of the first substrate; and
a reflection layer disposed between the second substrate and the second florescent layer,
wherein the first and second florescent layers are formed one of between the partition members or between the partition member and the sealing member.

12. The planar light source device of claim 11, wherein the partition members have a first partition member and a second partition member, the first partition member is adjacent to a first inner surface and makes contact with a second inner surface, and the second partition member is adjacent to the second inner surface and makes contact with the first inner surface.

13. The planar light source device of claim 11, wherein the partition members have a first partition member and a second partition member, wherein both the first and second partition members make contact with the second inner surface.

14. The planar light source device of claim 1, wherein the second electrode is disposed on an exterior area of one of the first and second substrates.

15. An image display apparatus comprising:
a planar light source device including a light source body having a first substrate, a second substrate facing the first substrate, at least one partition member disposed between the first and second substrates, the at least one partition member partitioning a space between the first and second substrates into a plurality of regions, and a sealing member sealing the space between the first and second substrates, a first electrode formed on both ends of the light source body in the direction that is substantially perpendicular to the longitudinal direction of the partition member, and a second electrode formed on the light source body in the direction that is substantially perpendicular to the first electrode, the second electrode being formed between the partition members and between the partition member and the sealing member;
a receiving container to mount the planar light source device; and
a flat panel to convert light generated from the planar light source device into images.

16. The image display apparatus of claim 15, wherein the second electrode is formed on one of the first and second substrates in the direction that is substantially perpendicular to the first electrode.

17. The image display apparatus of claim 16, wherein the second electrode is formed one of between the partition members or between the partition member and the sealing member.

18. The image display apparatus of claim 17, wherein the number of the second electrodes is more than 1.

19. The image display apparatus of claim 18, wherein the second electrodes are spaced apart from the first electrode.

20. The image display apparatus of claim 19, wherein the second electrodes are substantially symmetrical each other with respect to a central line of the first electrodes.

21. The image display apparatus of claim 15, wherein the second electrode is made of a conductive material.

22. The image display apparatus of claim 21, wherein the second electrode is made of a Silver (Ag) paste.
